(19) United States
(12) Patent Application Publication
(10) Pub. No.: US 2018/0173489 A1
(43) Pub. Date: Jun. 21, 2018

(54) INTELLIGENT PRESETS

(71) Applicant: BOSE CORPORATION, Framingham, MA (US)

(72) Inventors: Glenn Gomes-Casseres, Newton, MA (US); Santiago Carvajal, Ashland, MA (US)

(21) Appl. No.: 15/383,836

(22) Filed: Dec. 19, 2016

(51) Int. Cl. G06F 3/16; H04B 5/00; H04L 29/08

(52) U.S. Cl. CPC G06F 3/165; H04L 67/10; H04L 67/18; H04B 5/0056

(57) ABSTRACT

A method of assigning streaming audio content to a preset of a streaming audio player comprises identifying a user proximate to or operating the streaming audio player, identifying audio content preferred by the user, and configuring a preset of the streaming audio player play audio content similar to that preferred by the user.

### TECHNICAL FIELD

Aspects and implementations of the present disclosure are directed generally to streaming media player devices and specifically to systems and methods for intelligently modifying preset channels of same.

### BACKGROUND

Streaming media players, for example, streaming audio players, allow a user to access and stream content from external sources, for example, from Internet radio stations or other Internet-based streaming media service providers. Some streaming audio players include functionality for storing preset or favorite channels or stations such that a user may access a favorite channel or station by, for example, actuating a button or other feature associated with the favorite channel on the streaming audio player or on a controller for the streaming audio player.

### SUMMARY

In accordance with an aspect of the present disclosure, there is provided a method of assigning streaming audio content to a preset of a streaming audio player. The method comprises identifying one of a user proximate to or operating the streaming audio player or a device of a user proximate to the streaming audio player, identifying one of audio content preferred by the user or music present on the device, and configuring a preset of the streaming audio player such that user selection of the preset initiates playback of audio content that is one of similar to that preferred by the user or similar to that present on the device.

In some implementations, the method further comprises providing an indication of different audio content preferred by different users to the streaming audio player, and associating the different audio content with the respective different users in a memory of the streaming audio player.

In some implementations, associating the different audio content with the respective different users comprises associating different user-defined sets of preset assignments with respective users.

In some implementations, the method further comprises configuring presets of the streaming audio player to omit channels inappropriate for users proximate the streaming audio player.

In some implementations, identifying audio content preferred by the user includes identifying audio content selected by the user on the streaming audio player, saving a record of the audio content selected by the user in one of a memory of the streaming audio player or in a cloud-based account associated with the streaming audio player, and selecting audio content similar to that previously selected by the user as the audio content preferred by the user.

In some implementations, the method further comprises identifying different audio content selected by the user on the streaming audio player at different times, saving a record of the different audio content selected by the user and associated times the user selected the different audio content in one of the memory of the streaming audio player or in the cloud-based account associated with the streaming audio player, and configuring the preset of the streaming audio player such that user selection of the preset initiates playback of audio content similar to the different audio content previously selected by the user at a time matching a present time.

In some implementations, identifying the user includes the streaming audio player utilizing near field communication to identify the user.

In some implementations, identifying the user includes the streaming audio player utilizing wireless communication to identify the user via identifying a smart phone of the user.

In some implementations, identifying the user includes the streaming audio player utilizing biometrics to identify the user.

In some implementations, identifying the user includes identifying a user in a driver's seat of a vehicle in which the streaming audio player is installed.

In some implementations, the method further comprises the streaming audio player providing an indication of the user whom the preset of the streaming audio player is configured for.

In some implementations, the method further comprises configuring the preset based on a location of the streaming audio player.

In some implementations, the method further comprises configuring the preset based on one or more of a time of day or day of week.

In some implementations, the method further comprises configuring the preset based on weather in an area proximate the streaming audio player.

In some implementations, the method further comprises configuring the preset based on a schedule of the user.

In some implementations, the method further comprises the streaming audio player providing an indication to a change in content of an audio channel associated with the preset.

In accordance with another aspect there is provided a computer system comprising a processor and a non-transitory computer readable memory including instructions that when executed by the processor cause the computer system to identify a user proximate to or operating a streaming audio player, identify audio content preferred by the user, and configure a preset of the streaming audio player such that user selection of the preset initiates playback of audio content similar to that preferred by the user.

In some implementations, the instructions, when executed by the processor cause the computer system to identify the user by one or more of utilizing near field communication to identify the user, utilizing wireless communication to identify the user via identifying a smart phone of the user, or utilizing biometrics to identify the user.

In some implementations, the instructions, when executed by the processor cause the computer system to identify the audio content by identifying different audio content selected by the user on the streaming audio player at different times, saving a record of the different audio content selected by the user and associated times the user selected the different audio content in the memory of the computer system, and configuring the preset of the streaming audio player such that user selection of the preset initiates playback of audio content similar to the different audio content previously selected by the user at a time matching a present time.

In accordance with another aspect there is provided a streaming audio player comprising a processor, a network interface operatively coupled to the processor and configured to access streaming audio content from one or more streaming audio content sources, an electro-acoustic transducer operatively coupled to the processor, and a plurality of preset indicators operatively coupled to the processor. At least one of the plurality of preset indicators is an intelligent preset indicator configured to be assigned streaming audio content by a method including identifying a user proximate to or operating the streaming audio player, identifying audio content preferred by the user, and configuring the intelligent preset indicator of the streaming audio player such that user selection of the preset initiates playback of audio content similar to that preferred by the user.

In some implementations, the streaming audio player further comprises a memory operatively coupled to the processor. The memory includes programming which when executed by the processor causes the processor to access a cloud-based database including a record of different audio content selected by the user and associated times the user selected the different audio content, and configure the intelligent preset indicator of the streaming audio player play audio content similar to the different audio content previously selected by the user at a time matching a present time.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a perspective view of an exemplary streaming audio player;

FIG. 1B is a plan view of the streaming audio player of FIG. 1A;

FIG. 1C is a block diagram of the streaming audio player of FIG. 1A;

FIG. 2 illustrates a controller for the streaming audio player of FIG. 1A; and

FIG. 3 illustrates a computer system upon which aspects of methods disclosed herein may be performed.

### DETAILED DESCRIPTION

Aspects and implementations disclosed herein are not limited to the details of construction and the arrangement of components set forth in the following description or illustrated in the drawings. Aspects and implementations disclosed herein are capable of being practiced or of being carried out in various ways.

Aspects and implementations disclosed herein are generally directed to systems and methods for intelligently and/or dynamically modifying the presets of a streaming audio player to assign different streaming audio content, for example, different streaming audio stations or channels to the presets based on the context or environment in which the streaming audio player is used. The terms “stations” and “channels” are used interchangeably herein and encompass Internet radio channels, playlists from Internet streaming services, or other pre-defined locations or access points for accessing streaming audio or other audio content, for example, news, sports, weather, etc. It is to be understood that the disclosed streaming audio player may be utilized to stream music and/or audio content other than music. Further, the term “streaming audio player” as used herein encompasses an audio player itself, a controller for the streaming audio player, and computer systems associated with the streaming audio player configured to store information for the streaming audio player to access or to control or program the streaming audio player.

The systems and methods disclosed herein extend the functionality of streaming audio player presets, and expand the extent to which presets of a streaming audio player may be customized for a particular user, environment, or situation. In some implementations, a streaming audio player may include an intelligent preset or presets that adapt the type of content played when the intelligent preset is selected as the streaming audio player or associated computer system acquires information about a user and deduces or learns the preferences or tastes of a user.

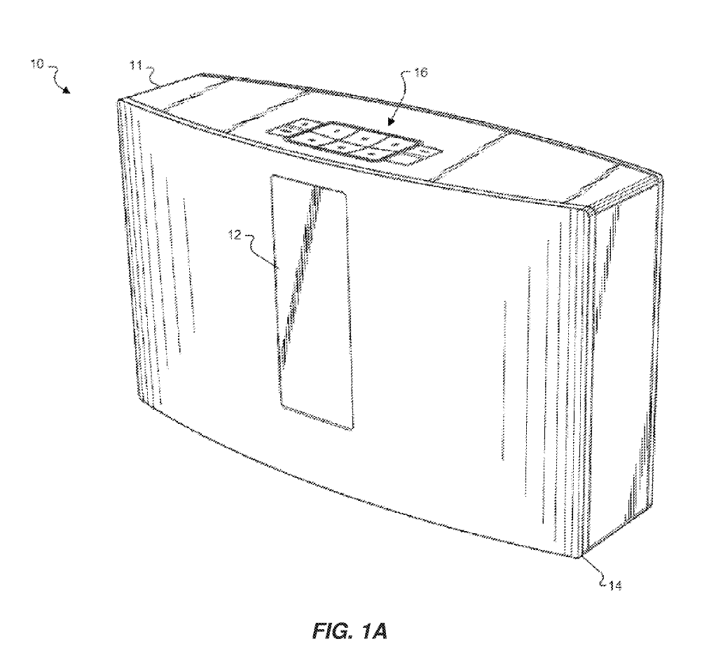

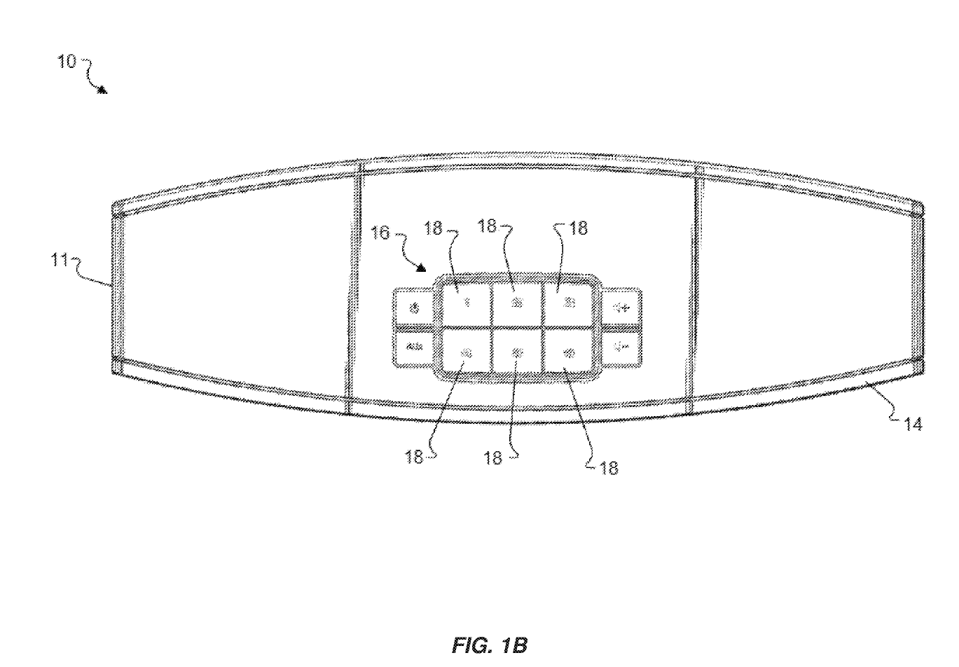

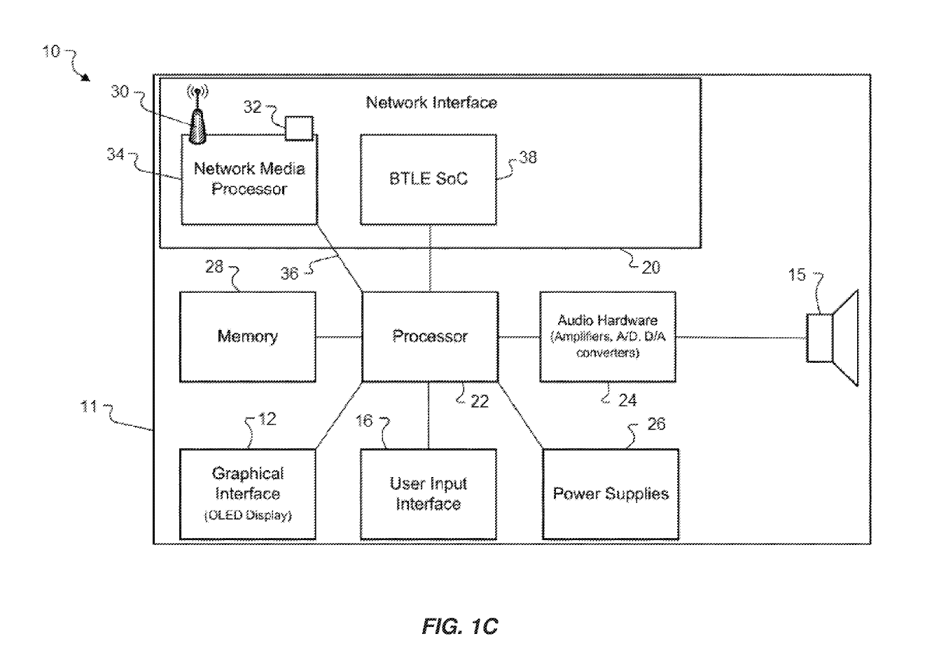

The aspects and implementations disclosed herein are generally applicable to any one of multiple streaming audio players. In one particular implementation, the streaming audio player is one of the SoundTouch® audio playback devices available from the Bose Corporation. An example of such a system is illustrated in FIGS. 1A-1C. This device is described in co-owned U.S. Pat. No. 9,330,169 “AUDIO SYSTEMS AND RELATED DEVICES AND METHODS,” which is incorporated herein by reference in its entirety for all purposes.

Referring to FIG. 1A, the audio playback device 10 includes an enclosure 11 and on the enclosure 11 there resides a graphical interface 12 (e.g., an OLED display) which can provide a user with information regarding currently playing (“Now Playing”) music and information regarding the presets. A screen 14 conceals one or more electro-acoustic transducers 15 (FIG. 1C). The audio playback device 10 also includes a user input interface 16. As shown in FIG. 1B, the user input interface 16 includes a plurality of preset indicators 18, which are hardware buttons in the illustrated example. The preset indicators 18 (numbered 1-6) provide the user with easy, one press access to entities assigned to those buttons. That is, a single press of a selected one of the preset indicators 18 will initiate streaming and rendering of content from the assigned entity or entities.

The assigned entities can be associated with different digital audio sources, for example, stations, channels, or playlists from Internet radio stations or streaming music services such as the Pandora®, Spotify®, vTuner®, iHeartRadio®, Deezer®, SiriusXM®, Amazon Music, etc. services. A single audio playback device 10 can provide for single press access to various different digital audio sources. In one example, the assigned entities include at least (i) user-defined playlists of digital music and (ii) Internet radio stations. In another example, the digital audio sources include a plurality of Internet radio sites, and the assigned entities include individual radio stations provided by those Internet radio sites.

Notably, the preset indicators 18 operate in the same manner, at least from the user's perspective, regardless of which entities are assigned and which of the digital audio sources provide the assigned entities. That is, each preset indicator 18 can provide for single press access to its assigned entity or entities whether an entity is a user-defined playlist of digital music provided by a network attached storage (NAS) device or an Internet radio station provided by an Internet music service.

With reference to FIG. 1C, the audio playback device 10 also includes a network interface 20, a processor 22, audio hardware 24, power supplies 26 for powering the various audio playback device components, and memory 28. Each of the processor 22, the graphical interface 12, the network interface 20, the audio hardware 24, the power supplies 26, and the memory 28 are interconnected using various buses, and several of the components may be mounted on a common motherboard or in other manners as appropriate.

The network interface 20 provides for communication between the audio playback device 10 and a controller (for example, a remote control or a smart phone or computer having an appropriate control application installed), a server connected to the Internet or cloud-based server that may contain an account database including information regarding an audio system account of a user, audio sources, and other audio playback devices 10 via one or more communications protocols. The network interface 20 may provide either or both of a wireless interface 30 and a wired interface 32. The wireless interface 30 allows the audio playback device 10 to communicate wirelessly with other devices in accordance with a communication protocol such as such as IEEE 802.11b/g. The wired interface 32 provides network interface functions via a wired (e.g., Ethernet) connection.

In some examples, the network interface 20 may also include a network media processor 34 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to a LAN which the audio playback device 10 is in communication with, the user can then stream music to the network connected audio playback devices 10 via Apple AirPlay®. A suitable network media processor is the DM870 processor available from SMSC of Hauppauge, N.Y. The network media processor 34 provides network access (e.g., the Wi-Fi network and/or Ethernet connection can be provided through the network media processor 34) and AirPlay® audio. AirPlay® audio signals are passed to the processor 22, using the I2S protocol (an electrical serial bus interface standard used for connecting digital audio devices), for downstream processing and playback. Notably, the audio playback device 10 can support audio-streaming via AirPlay® and/or DLNA's UPnP protocols, and all integrated within one device.

All other digital audio coming from network packets comes straight from the network media processor 34 through a USB bridge 36 to the processor 22 and runs into the decoders, DSP, and eventually is played back (rendered) via the electro-acoustic transducer(s) 15.

The network interface 11 can also include a Bluetooth low energy (BTLE) system-on-chip (SoC) 738 for Bluetooth low energy applications (e.g., for wireless communication with a Bluetooth enabled controller. A suitable BTLE SoC is the CC2540 available from Texas Instruments, with headquarters in Dallas, Tex.

Streamed data pass from the network interface 20 to the processor 22. The processor 22 can execute instructions within the audio playback device (e.g., for performing, among other things, digital signal processing, decoding, and equalization functions), including instructions stored in the memory 28. The processor 22 may be implemented as a chipset of chips that include separate and multiple analog and digital processors. The processor 22 may provide, for example, for coordination of other components of the audio playback device 10, such as control of user interfaces, or applications run by the audio playback device 10. A suitable processor is the DA921 available from Texas Instruments.

The processor 22 provides a processed digital audio signal to the audio hardware 24 which includes one or more digital-to-analog (D/A) converters for converting the digital audio signal to an analog audio signal. The audio hardware 24 also includes one or more amplifiers which provide amplified analog audio signals to the electroacoustic transducer(s) 15 for playback. In addition, the audio hardware 24 may include circuitry for processing analog input signals to provide digital audio signals for sharing with other devices.

The memory 28 stores information within the audio playback device 10. In this regard, the memory 28 may store account information, such as information regarding the audio station or channel presets. The memory 28 may also provide storage for “tokens” for facilitating single press access to the digital audio sources, for example, Internet radio services. A token, as used herein, is a unique identifier that may be provided by a digital audio source and which allows the digital audio source to recognize the audio playback device 10 as being associated with a user's account with the digital audio source and without requiring the user to enter credentials (e.g., user name, password, etc.) each time the audio playback device 10 attempts to access the digital audio source.

The memory 28 may include, for example, flash memory and/or non-volatile random access memory (NVRAM). In some implementations, instructions (e.g., software) are stored in an information carrier. The instructions, when executed by one or more processing devices (e.g., the processor 22), perform one or more processes, such as those described below for assigning stations, channels, or playlists to the preset indicators 18 of the streaming audio player. The instructions can also be stored by one or more storage devices, such as one or more computer- or machine-readable mediums (for example, the memory 28, or memory on the processor). The instructions may include instructions for performing decoding (i.e., the software modules include the audio codecs for decoding the digital audio streams), as well as digital signal processing and equalization. In accordance with some aspects and implementations, the memory 28 includes instructions, that when executed by the processor causes the processor to access a cloud-based database including account information associated with the audio playback device 10 including a set of user-defined audio channel presets and to assign the user-defined audio channel presets to the plurality of preset indicators 18.

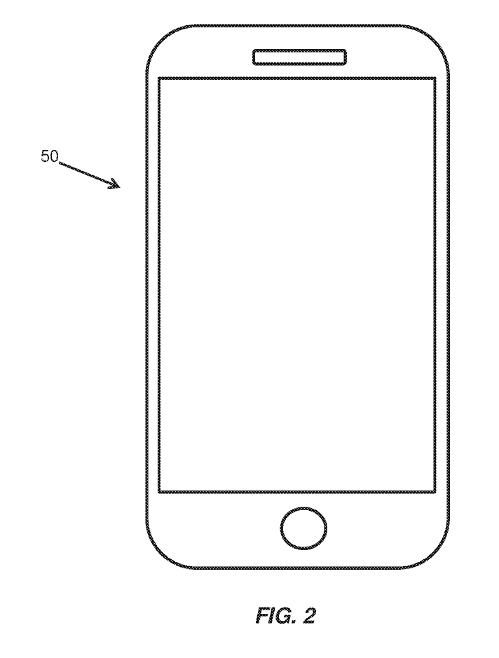

A user may operate the streaming audio player by interacting directly with the user input interface 16. Alternatively, a user may operate the streaming audio player using an app installed on a streaming audio player controller, for example, a smart phone 50 (FIG. 2) or other mobile device. In some implementations, in addition to or as an alternative to assigning content to hardware preset indicators 18 provided on the streaming music player, content may be assigned to “virtual presets” that are accessible and selectable through the app installed on the streaming music player controller. Accordingly, discussion herein of assigning content to the preset indicators 18 of the streaming music player applies equally to assigning content to “virtual presets” accessible and selectable through the app installed on the streaming music player controller.

In some implementations a streaming audio player may include an intelligent preset or presets that make changes to the type of audio content played responsive to the intelligent preset(s) being selected based on which user is operating the streaming audio player or is present near the streaming audio player. Different users, for example different family members in a home in which a streaming audio player is installed, may have different preferences for audio content to listen to through the streaming audio player. For example, a father might enjoy “oldies” music and talk radio such as National Public Radio (NPR), while a son might prefer rock and roll and sports channels and a mother might enjoy classical music. Such preferences could be provided to the streaming audio player, for example, by identifying particular stations or channels preferred by different family members and associating the different stations or channels with the different family members in a memory of the streaming audio player, streaming audio player controller, or cloud-based account associated with the streaming audio player.

In some implementations, the streaming audio player (or associated computer system, for example, that hosts a cloud-based account associated with the streaming audio player) may be programmed or instructed to modify the intelligent preset(s) of the streaming audio player based on the composition of an audience proximate the streaming audio player. For example, if the streaming audio player is provided information or senses that children are in the presence of the streaming audio player, the intelligent preset(s) of the streaming audio player may be set to avoid channels that play music with explicit lyrics or other music or content inappropriate for children.

In some implementations, the streaming audio player is not pre-programmed with channels to associate with different users and assign to intelligent presets in the presence of the different users, but rather is configured to learn preferences of the different users over time and associate channels consistent with these preferences to the various users. For example, the streaming audio player may identify a user operating the streaming audio player by one of the methods descried in further detail below and monitor what types of audio content the user listens to on the streaming audio player. The streaming audio player may store a record associating the audio content listened to by the user with the user in a memory of the streaming audio player or in an online account associated with the streaming audio player or user. The streaming audio player may then assign an intelligent preset of the streaming audio player to a channel providing audio content similar to that which the user selected in the past when the user is in the presence of or operating the streaming audio player. The audio content similar to that which the user selected in the past or audio content similar to that preferred by the user may include either audio content that is similar to, but not identical to audio content the user has selected in the past, may include or consist of specific audio content that the user has selected in the past, or may include both audio content that is similar to, but not identical to audio content the user has selected in the past and specific audio content that the user has selected in the past.

The assignment of channels to the intelligent presets of the streaming audio player based on the user may be further refined by storing a record of not only what audio content the user listened to, but what different types of audio content, if any, the user listened to at different times of the day, days of the week, months of the year, etc. The streaming audio player may then assign an intelligent preset of the streaming audio player to a channel providing audio content similar to that which the user selected in the past at a similar time, day, month, etc. as a present time, day, month etc., when the user is in the presence of or is operating the streaming audio player.

In some implementations, the streaming audio player need not identify a user, but rather may identify a device of a user, for example, a smartphone or portable audio player. The streaming audio player may read what audio content is present on the device and assign similar audio content to an intelligent preset. The similar audio content may include either audio content that is similar to, but not identical to audio content present on the device, may include or consist of specific audio content present on the device, or may include both audio content that is similar to, but not identical to audio content present on the device and specific audio content present on the device. If the device of the user maintains a record of what audio content was played when in the past the streaming audio player may then assign an intelligent preset of the streaming audio player to a channel providing audio content similar to that which was played on the device in the past at a similar time, day, month, etc. as a present time, day, month etc., when the device is in the presence of the streaming audio player.

The streaming audio player may program one or more presets to play audio content from a channel associated with a particular user when the particular user is detected in the presence of the streaming audio player. For example, responsive to detecting a particular user in the presence of the streaming audio player, the streaming audio player may access a cloud-based system that maintains profiles on different users, including the audio content preferences of the different users. The streaming audio player may access the profile of the user detected in the presence of the streaming audio player to determine the audio content preferences of the user, and program an intelligent preset to play content consistent with the audio content preferences of the user. In some cases, the audio content preferences may include a set of preset assignments that are predefined by the user him or herself. For example, in some cases, each of a plurality of users may have a corresponding user-defined set of preset assignments stored in a computer memory, and, when a particular user is detected by the streaming audio player, the presets are automatically programmed with the set of preset assignments that were defined by the detected user. The presets can then be dynamically reprogrammed when another one of the users is detected. When multiple users are present, preference may be given to the user that is detected to be closest in proximity to the streaming audio player.

In some implementations, the streaming audio player need not identify the user, but only the device (e.g., smart phone) of the user. Responsive to detecting a particular device in the presence of the streaming audio player, the streaming audio player may access a cloud-based system that maintains profiles on different devices, including the audio content preferences of users of the different devices. The streaming audio player may access the profile of the device detected in the presence of the streaming audio player to determine the audio content preferences associated with the device, and program an intelligent preset to play content consistent with the audio content preferences associated with the device.

In some implementations, the streaming audio player, the controller of the streaming audio player, or another device in communication with the streaming audio player may utilize a form of near field communication (NFC) to identify persons proximate the streaming audio player. For example, a user may bring the user's smart phone into proximity of the streaming audio player or the controller of the streaming audio player. The smart phone may be programmed with an app that communicates the user's identity to the streaming audio player or the controller of the streaming audio player or, alternatively or additionally, the streaming audio player or the controller of the streaming audio player may have been previously provided with the IP address of the user's smart phone and the streaming audio player or the controller of the streaming audio player may identify the smart phone and hence the user by reading the smart phone's IP address. The streaming audio player or the controller of the streaming audio player may utilize other wireless protocols, for example, BLUETOOTH® and/or Wi-Fi to identify a user through their smart phone in a similar manner.

In other implementations, the streaming audio player or the controller of the streaming audio player (or other device in communication with the streaming audio player) may identify a user through biometrics. For example, the streaming audio player or the controller of the streaming audio player (or other device in communication with the streaming audio player) may be equipped with a fingerprint reader and may be programmed to associate different fingerprints with different users. The streaming audio player or the controller of the streaming audio player (or other device in communication with the streaming audio player) may be equipped with a microphone and may be programmed to associate different voices or voice patterns with different users and thus may identify a user by their voice. In further implementations, the streaming audio player or the controller of the streaming audio player (or other device in communication with the streaming audio player) may be equipped with a camera and may be programmed to identify different users through facial recognition or gait recognition.

In some implementations, if a person the streaming audio player does not recognize approaches the streaming audio player, the streaming audio player may assume that the person is a guest and may allow the guest to override the customized programming of the intelligent presets of the streaming audio player.

In some implementations a streaming audio player may be installed in a vehicle. The streaming audio player may have intelligent presets that modify the source(s) of audio content played responsive to activation of one or more of the presets based on who is driving the car. The streaming audio player may identify the user who is in the driver's seat of the vehicle by communicating with the user's smartphone or by biometric analysis of the user as discussed above. In some implementations, the intelligent presets are automatically modified responsive to the user entering the driver's seat of the vehicle. In other implementations, the user takes an action, for example, selecting a button on an app running on their smartphone that sends a message to the streaming audio player to modify the intelligent presets to stream audio content that the user prefers.

A streaming audio player may provide an indication of what user the intelligent preset(s) of the streaming audio player have been customized for. In some implementations, an intelligent preset indicator may be provided with lighting, for example, one or more LEDs that change color based on which user the intelligent preset(s) of the streaming audio player have been customized for. In other implementations, a display screen of the streaming audio player may change color based on the user the intelligent preset(s) of the streaming audio player have been customized for or may provide a text indication of the name of the user the intelligent preset(s) of the streaming audio player have been customized for.

In other implementations, a streaming audio player may modify the sources of audio content associated with intelligent presets of the streaming audio player based on a location of the streaming audio player. For example, for a streaming audio player installed in a vehicle, the streaming audio player may alter one or more presets to provide traffic information to a user when the vehicle is in a location distant from a home of the user or in a location in which the vehicle is rarely present.

A streaming audio player may modify the source(s) of audio content associated with intelligent presets of the streaming audio player based on time of day or day of the week. For example, a user may prefer to listen to the day's news and to energetic music in the morning and may prefer to listen to financial news in the evening after the financial markets have closed as well as sports updates during the evening or weekend when various sports games the user in interested in are being played. For a streaming audio player installed in a vehicle, a user may prefer to listen to traffic updates on weekdays during times the user is usually commuting to work. The streaming audio player may modify the source(s) of audio content associated with intelligent preset(s) of the streaming audio player to play audio content to accommodate these or other user preferences.

A streaming audio player may modify the source(s) of audio content associated with intelligent presets of the streaming audio player based on the weather. For example, if severe weather (hurricane, tornado, blizzard etc.) is predicted or occurring in an area proximate the streaming audio player, the streaming audio player may modify an intelligent preset to provide audio content from a source reporting on developments in the weather. In other examples, on warm summer days, the streaming audio player may modify an intelligent preset to provide audio content from a source playing summer or beach themed music.

A streaming audio player (or associated computer system, for example, that hosts a cloud-based account associated with the user or streaming audio player) may modify the source(s) of audio content associated with intelligent presets of the streaming audio player based on a user's schedule, for example, based on whether the user is on vacation, at work, or based on events in a user's electronic schedule (e.g., a schedule in a user's Microsoft Outlook account) that the user has provided for the streaming audio player or associated computer system to access. If it is a work day for the user, the streaming audio player may assign a channel reporting on business news related to the user's profession to an intelligent preset of the streaming audio player. If the user is on vacation, the streaming audio player may assign a channel reporting on weather or local entertainment or community events to an intelligent preset of the streaming audio player. If the user's electronic schedule indicates that the user is scheduled to make an important presentation, the streaming audio player may assign a channel playing relaxing music to an intelligent preset of the streaming audio player. If the user's electronic schedule instead indicates that the user is scheduled to attend a company party, the streaming audio player may assign a channel playing upbeat music to an intelligent preset of the streaming audio player.

In some implementations, a streaming audio payer may provide an indication that a preset of the streaming audio player has been updated or modified to play different content or content from a different channel. In some implementations a streaming audio content provider may update a channel associated with a preset of the streaming audio player with new content. The streaming audio player may provide a message to a user, for example, through a display of the streaming audio player of the content update. In other implementations, the streaming audio player may provide a sound or audio message to a user informing the user of the content update. In further implementations, the streaming audio player may visually change a preset indicator associated with the preset having the updated content, for example, by illuminating the preset indicator or causing the preset indicator to blink.

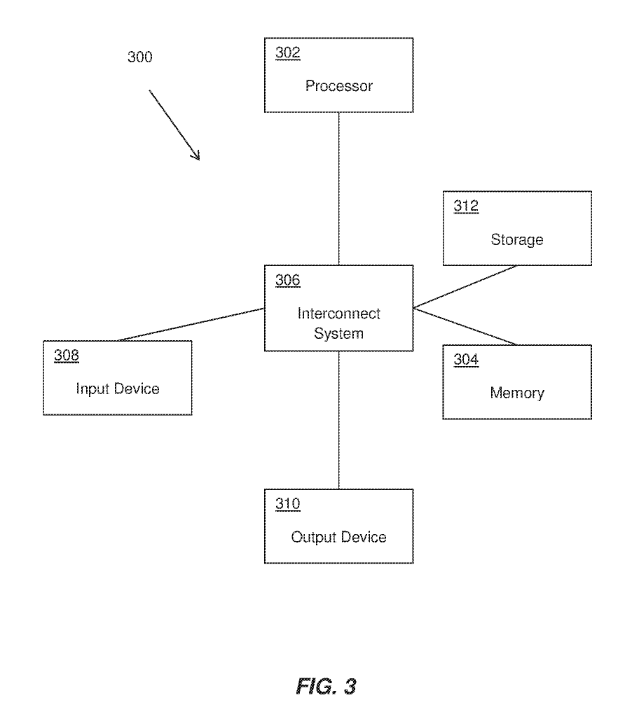

The various computer systems disclosed herein, for example, a computer system hosting the online streaming audio account of a user, the streaming audio controller 50, or a computer system that is used to make predictions of what type of audio content and scheduling for same the user might enjoy and to program a dynamically adjustable preset for the user, may include specialized software executing in a general-purpose computer system 300 such as that shown in FIG. 3. The computer system 300 may include a processor 302 connected to one or more memory devices 304, such as a disk drive, solid state memory, or other non-transitory recording medium for storing data. Memory 304 is typically used for storing programs and data during operation of the computer system 300. Components of computer system 300 may be coupled by an interconnection mechanism 306, which may include one or more busses (e.g., between components that are integrated within a same machine) and/or a network (e.g., between components that reside on separate discrete machines). The interconnection mechanism 306 enables communications (e.g., data, instructions) to be exchanged between system components of system 300. Computer system 300 also includes one or more input devices 308, for example, a keyboard, mouse, trackball, microphone, touch screen, and one or more output devices 310, for example, a printing device, display screen, and/or speaker.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects and embodiments disclosed herein may be practiced, it should be appreciated that aspects and implementations disclosed herein are not limited to being implemented on the computer system as shown in FIG. 3. Various aspects and implementations disclosed herein may be practiced on one or more computers having a different architecture or components than shown in FIG. 3.

Computer system 300 may be a general-purpose computer system that is programmable using a high-level computer programming language. Computer system 300 may be also implemented using specially programmed, special purpose hardware. In computer system 300, processor 302 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 300 may communicate with one or more other components over a wireless network, including, for example, a cellular telephone network.

It should be appreciated that the aspects and implementations disclosed herein are not limited to executing on any particular system or group of systems. Also, it should be appreciated that the aspects and implementations disclosed herein are not limited to any particular distributed architecture, network, or communication protocol. Various aspects and implementations disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example, ladder logic. Various aspects and implementations disclosed herein may be implemented in a non-programmed environment (e.g., documents created in HTML, XML or other format that, when viewed in a window of a browser program, render aspects of a graphical-user interface (GUI) or perform other functions). Various aspects and implementations s disclosed herein may be implemented as programmed or non-programmed elements, or any combination thereof.

Having thus described several aspects of at least one implementation, it is to be appreciated various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of assigning streaming audio content to a preset of a streaming audio player, the method comprising:
identifying one of a user proximate to or operating the streaming audio player or a device of a user proximate to the streaming audio player;
identifying one of audio content preferred by the user or music present on the device; and
configuring a preset of the streaming audio player such that user selection of the preset initiates playback of audio content that is one of similar to that preferred by the user or similar to that present on the device.

2. The method of claim 1, further comprising:
providing an indication of different audio content preferred by different users to the streaming audio player; and
associating the different audio content with the respective different users in a memory of the streaming audio player.

3. The method of claim 2, wherein associating the different audio content with the respective different users comprises associating different user-defined sets of preset assignments with respective users.

4. The method of claim 1, further comprising configuring presets of the streaming audio player to omit channels inappropriate for users proximate the streaming audio player.

5. The method of claim 1, wherein identifying audio content preferred by the user includes:
identifying audio content selected by the user on the streaming audio player;
saving a record of the audio content selected by the user in one of a memory of the streaming audio player or in a cloud-based account associated with the streaming audio player; and
selecting audio content similar to that previously selected by the user as the audio content preferred by the user.

6. The method of claim 5, further comprising:
identifying different audio content selected by the user on the streaming audio player at different times;
saving a record of the different audio content selected by the user and associated times the user selected the different audio content in one of the memory of the streaming audio player or in the cloud-based account associated with the streaming audio player; and
configuring the preset of the streaming audio player such that user selection of the preset initiates playback of audio content similar to the different audio content previously selected by the user at a time matching a present time.

7. The method of claim 1, wherein identifying the user includes the streaming audio player utilizing near field communication to identify the user.

8. The method of claim 1, wherein identifying the user includes the streaming audio player utilizing wireless communication to identify the user via identifying a smart phone of the user.

9. The method of claim 1, wherein identifying the user includes the streaming audio player utilizing biometrics to identify the user.

10. The method of claim 1, wherein identifying the user includes identifying a user in a driver's seat of a vehicle in which the streaming audio player is installed.

11. The method of claim 1, further comprising the streaming audio player providing an indication of the user whom the preset of the streaming audio player is configured for.

12. The method of claim 1, further comprising configuring the preset based on a location of the streaming audio player.

13. The method of claim 1, further comprising configuring the preset based on one or more of a time of day or day of week.

14. The method of claim 1, further comprising configuring the preset based on weather in an area proximate the streaming audio player.

15. The method of claim 1, further comprising configuring the preset based on a schedule of the user.

16. The method of claim 1, further comprising the streaming audio player providing an indication to a change in content of an audio channel associated with the preset.

17. A computer system comprising a processor and a non-transitory computer readable memory including instructions that when executed by the processor cause the computer system to:
identify a user proximate to or operating a streaming audio player;
identify audio content preferred by the user; and
configure a preset of the streaming audio player such that user selection of the preset initiates playback of audio content similar to that preferred by the user.

18. The system of claim 17, wherein the instructions, when executed by the processor cause the computer system to identify the user by one or more of utilizing near field communication to identify the user, utilizing wireless communication to identify the user via identifying a smart phone of the user, or utilizing biometrics to identify the user.

19. The system of claim 17, wherein the instructions, when executed by the processor cause the computer system to identify the audio content by:
identifying different audio content selected by the user on the streaming audio player at different times;
saving a record of the different audio content selected by the user and associated times the user selected the different audio content in the memory of the computer system; and
configuring the preset of the streaming audio player such that user selection of the preset initiates playback of audio content similar to the different audio content previously selected by the user at a time matching a present time.

20. A streaming audio player comprising:
a processor;
a network interface operatively coupled to the processor and configured to access streaming audio content from one or more streaming audio content sources;
an electro-acoustic transducer operatively coupled to the processor;
a plurality of preset indicators operatively coupled to the processor, at least one of the plurality of preset indicators being an intelligent preset indicator configured to be assigned streaming audio content by a method including:
identifying a user proximate to or operating the streaming audio player;
identifying audio content preferred by the user; and
configuring the intelligent preset indicator of the streaming audio player such that user selection of the preset initiates playback of audio content similar to that preferred by the user.

21. The streaming audio player of claim 20, further comprising a memory operatively coupled to the processor, the memory including programming which when executed by the processor causes the processor to:
access a cloud-based database including a record of different audio content selected by the user and associated times the user selected the different audio content; and
configure the intelligent preset indicator of the streaming audio player play audio content similar to the different audio content previously selected by the user at a time matching a present time.
